(19) United States
(12) Patent Application Publication
(10) Pub. No.: US 2010/0172335 A1
(43) Pub. Date: Jul. 8, 2010

(54) Data transmission method and apparatus based on Wi-Fi multimedia

(75) Inventor: In Young Mok, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/655,796

(22) Filed: Jan. 7, 2010

(30) Foreign Application Priority Data
Jan. 8, 2009 (KR) 10-2009-0001434

(51) Int. Cl. H04W 40/00

(52) U.S. Cl. 370/338

(57) ABSTRACT

An apparatus can transmit data based on Wi-Fi Multimedia. The apparatus utilizes different retransmission limits for different service types or access categories. Therefore, it is possible to perform data transmission conforming to characteristics of specific services. In particular, the retransmission limit for a data transfer service emphasizing a real-time constraint is set to a value less than that for a data transfer service emphasizing an error-free delivery constraint.

### CROSS-REFERENCE TO RELATED APPLICATION(S) AND CLAIM OF PRIORITY

The present application is related to and claims priority to an application entitled “DATA TRANSMISSION METHOD AND APPARATUS BASED ON WI-FI MULTIMEDIA” filed in the Korean Intellectual Property Office on Jan. 8, 2009 and assigned Serial No. 10-2009-0001434, the contents of which are incorporated herein by reference.

### TECHNICAL FIELD OF THE INVENTION

The present invention relates generally to a data transmission method and apparatus and, more particularly, to a data transmission method and apparatus that can achieve more acceptable transmission quality in data transmission based on Wi-Fi Multimedia by applying different retransmission limits to different types of services.

### BACKGROUND OF THE INVENTION

The IEEE 802.11 standards (Wi-Fi) for wireless local area networks (WLAN) provide various technical specifications that enable mobile devices to access wired networks through access points (AP). In particular, based on the IEEE 802.11e standard, Wi-Fi Multimedia (WMM), also known as Wireless Multimedia Extensions (WME), provides quality of service (QoS) features by prioritizing traffic according to four access categories (AC)—audio, video, best effort, and background. The WMM technology is suitable for simple applications requiring QoS features such as Unlicensed Mobile Access (UMA). UMA supports handover between a GSM/GPRS network and an IP (Internet Protocol) network through VoIP (Voice over IP) technology, and enables voice calls through an IP network. A UMA-enabled mobile node may access an IP network through a WLAN.

As VoIP technology employs an IP network including network devices such as routers, domain name servers and address translators, it may cause time delay in data transmission. In IP networks, data packets sent in order by a source device may not arrive in the same order at a destination device or their arrival times may be not uniform (jitter). To handle this problem, a mobile node may be equipped with a jitter buffer that stores particular data packets and forwards them to an audio processor.

However, an existing mobile node tends to apply the same criteria to handling data loss or excessive time delay in data transmission regardless of service types. Hence, the existing mobile node may not adequately support specific services according to their types.

### SUMMARY OF THE INVENTION

To address the above-discussed deficiencies of the prior art, it is a primary object to provide a data transmission method and apparatus based on Wi-Fi Multimedia that can perform data transmission conforming to characteristics of specific services by applying different retransmission limits to different services types (i.e., access categories).

In accordance with an exemplary embodiment of the present invention, there is provided a data transmission method based on Wi-Fi Multimedia, including: identifying an access category to be used for data transmission between a sending end and a receiving end; setting, by the sending end, different retransmission limits for different access categories; sending, by the receiving end, a retransmission request for missing data to the sending end; and determining, by the sending end, whether to retransmit the requested data through comparison between the number of retransmission requests received and the retransmission limit related to the identified access category.

In accordance with another exemplary embodiment of the present invention, there is provided a data transmission apparatus based on Wi-Fi Multimedia, including: a sending end setting different retransmission limits for different access categories, and determining, upon reception of a retransmission request, whether to retransmit the requested data through comparison between the number of retransmission requests received and the retransmission limit related to a selected access category; and a receiving end sending a retransmission request for missing data to the sending end.

In a feature of the present invention, the data transmission method and apparatus based on WMM can adequately support specific services in conformance with their access categories by intelligently limiting the number of retransmissions according to service types.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, May mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a data transmission system according to an exemplary embodiment of the present invention;

FIG. 2 is a block diagram of a mobile node in the system of FIG. 1;

FIG. 3 illustrates a control unit in the mobile node of FIG. 2;

FIG. 4 illustrates a retransmission table;

FIG. 5 is a sequence diagram of a data transmission method according to another exemplary embodiment of the present invention; and

FIG. 6 is a flow chart of a procedure performed by the mobile node in the data transmission method of FIG. 5.

### DETAILED DESCRIPTION OF THE INVENTION

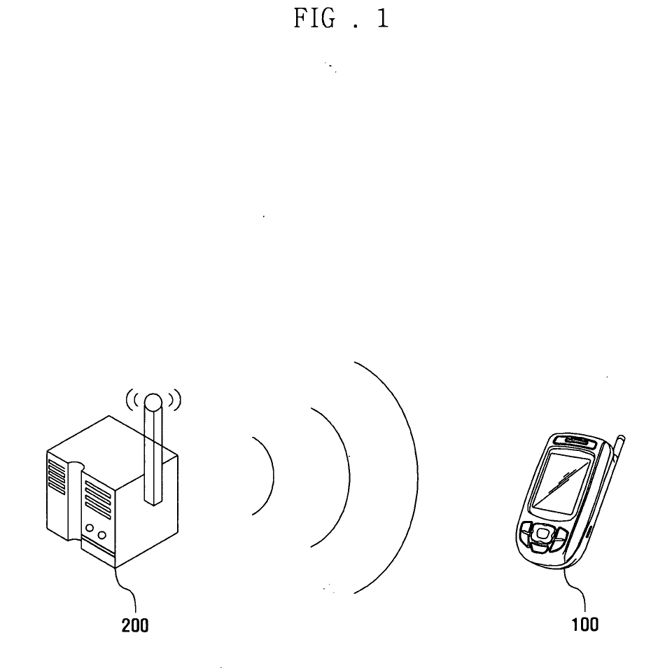

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

The present invention relates to data transmission between a sending end and a receiving end wherein different retransmission limits are applied to different access categories. For the purpose of description, it is illustrated that the sending end is a mobile node and the receiving end is an access point (AC). However, the present invention is not limited thereto. The sending end may be a mobile node, AP or other network element; and the receiving end may be a mobile node, AP or other network element.

FIG. 1 illustrates a data transmission system based on WMM according to an exemplary embodiment of the present invention.

Referring to FIG. 1, the data transmission system includes an AP 200 and a mobile node 100. The AP 200 acts as an interface entity that enables the mobile node 100 to access a network. The data transmission system may further include other network entities (not shown) connected to the AP 200. The data transmission system may include a sending end AP to which the mobile node 100 is connected, and a receiving end AP to which a second mobile node is connected, wherein the mobile node 100 transmits data to the second mobile node. In the following description, the AP 200 is depicted as a representative network entity.

The AP 200 acts as a contact point or a point of interface between the user and a network for private line or value added network services. A user terminal or computer may connect to the network through a private line or telephone line leading to the contact point. The AP 200 may include a data circuit-terminating equipment (DCE) and a time division multiplexer (TDM). The AP 200 may be simultaneously connected to multiple mobile nodes. In particular, the AP 200 may provide services based on WMM to the mobile node 100 according to access categories. To be more specific, when the mobile node 100 that includes a communication module capable of accessing the AP 200 approaches the AP 200 and makes a registration request, the AP 200 may allocate an IP address to the mobile node 100. When the mobile node 100 attempts to access the network through the AP 200, the AP 200 and the mobile node 100 exchange signals to set an access category. Thereafter, the AP 200 relays data between the mobile node 100 and a counterpart mobile node or server through the network according to the set access category.

The mobile node 100, including a communication module capable of connecting to the AP 200 supporting WMM, approaches the AP 200, and may obtain an IP address from the AP 200. In response to a user request, the mobile node 100 activates a requested one of available services such as an audio service, video service and data transfer service. At this time, the mobile node 100 notifies the AP 200 of the access category associated with the activated service, and transmits data related to the activated service to the AP 200. In particular, the mobile node 100 may limit the number of retransmissions according to the access category for data transmission conforming to service characteristics. To be more specific, an audio service may have a more strict real-time constraint in comparison with other services such as a video service and a best effort or background data transfer service. For a data transfer service, lossless delivery may be more important than real-time delivery. In the mobile node 100, the retransmission limit for an access category in which real-time delivery is more important than lossless delivery is set to a small value; and the retransmission limit for an access category in which lossless delivery is more important than real-time delivery is set to a large value. Therefore, different retransmission limits are assigned to different access categories, enabling data transmission conforming to service characteristics. The mobile node 100 may use a static scheme in which the retransmission limits assigned to the individual access categories do not change, or a dynamic scheme in which the retransmission limits to the individual access categories may be changed according to the situations. Next, a detailed description is given of the configuration and operation of the mobile node 100.

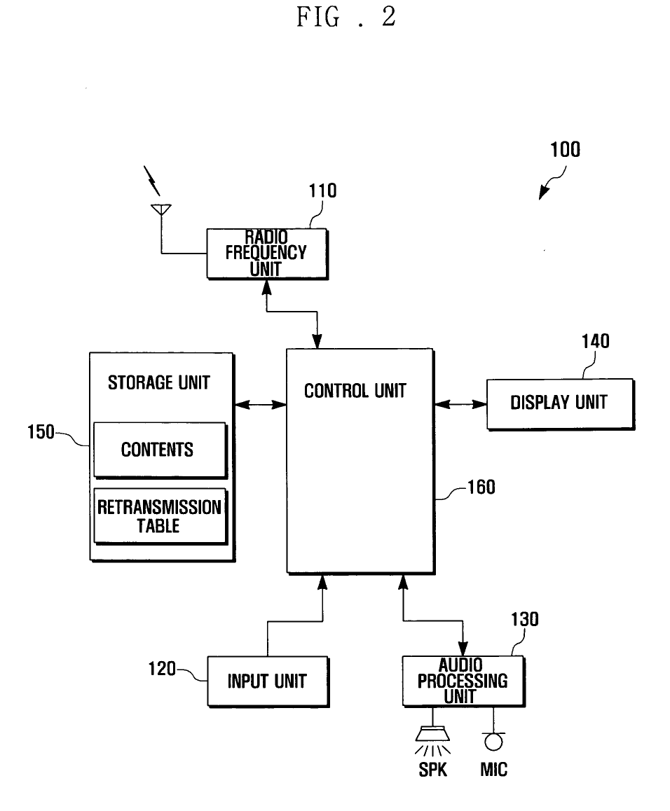

FIG. 2 illustrates a block diagram of the mobile node 100.

Referring to FIG. 2, the mobile node 100 may include a radio frequency unit 110, an input unit 120, an audio processing unit 130, a display unit 140, a storage unit 150, and a control unit 160.

The mobile node 100 that includes the above configuration, in response to an input signal from the input unit 120, may select an access category and send the access category through the radio frequency unit 110 to the AP 200, or may exchange signals with the AP 200 to determine the access category. After determining the access category, the mobile node 100 determines the retransmission limit related to the access category, and may perform data retransmission within the retransmission limit if retransmission is necessary. If data is not successfully transmitted before the number of retransmissions exceeds the retransmission limit, the mobile node 100 may treat the data as lost.

The radio frequency unit 110 establishes a communication channel to the AP 200 to provide a service of a given access category, and performs data transmission under the control of the control unit 160. In particular, under the control of the control unit 160, the radio frequency unit 110 may collect information regarding radio environments related to data transmission through communication with the AP 200, and adjust the rate of data transmission on the basis of the collected information. The radio frequency unit 110 may include a radio frequency transmitter for upconverting the frequency of a signal to be transmitted and amplifying the signal. The radio frequency unit 110 may also include a radio frequency receiver for low-noise amplifying a received signal and downconverting the frequency of the received signal.

The input unit 120 includes a plurality of alphanumeric and function keys for inputting alphanumeric information and for setting various functions. The function keys may include direction, side, and shortcut keys associated with corresponding functions. The input unit 120 transmits key signals from the user for setting and controlling the mobile node 100 to the control unit 160. In particular, the input unit 120 may generate an input signal for selecting a desired service of a given access category. That is, in response to a user request, the input unit 120 may generate a signal for activating one of an audio service, a video service, a best effort data transfer service and a background data transfer service, and send the generated signal to the control unit 160.

The audio processing unit 130 includes a speaker SPK for outputting an audio signal from the control unit 160, and a microphone MIC for collecting an audio signal related to an activated application program. In particular, when an audio service is activated in response to a user request, the audio processing unit 130 collects an audio signal through the microphone MIC, converts the audio signal into a data signal, and sends the data signal to the control unit 160. The audio processing unit 130 may output an audio signal, which is received from the AP 200 and decoded, through the speaker SPK.

The display unit 140 displays various menus, information input by the user, and information to be provided to the user. For example, the display unit 140 may output various screens related to utilization of the mobile node 100, such as an idle screen, menu screen, message composition screen, and call handling screen. In particular, the display unit 140 may present a screen for setting retransmission limits according to the access categories. That is, when the user makes a request for a data transfer service of a particular access category through the input unit 120, the display unit 140 may display a popup window or menu for setting the retransmission limit for the access category. The retransmission limit may be automatically set to a default value without display of a window or menu under the control of the control unit 160 according to user settings. The display unit 140 may include a liquid crystal display (LCD). If the LCD includes a touch screen capability, the display unit 140 may act as an input means. In this case, the display unit 140 may include a display panel and a touch sensor placed on the display panel, and the mobile node 100 may provide various menu screens responsive to touch events.

The storage unit 150 may store application programs related to the present invention, application programs for playing back various media files, and key maps or menu maps for the touch screen capability. The key maps may correspond to various keyboards including a 3*4 keyboard and a qwerty keyboard, and may include a control key map for controlling execution of an activated application program. The menu maps may include a menu map for controlling execution of an activated application program, and a menu map related to the menus of the mobile node 100. The storage unit 150 may include a program area and a data area.

The program area may store an operating system (OS) for booting and operating the mobile node 100, and various application programs related to transmission of data, reproduction of audio files, and viewing of still images and moving images. In particular, the program area may store a retransmission control program for setting retransmission limits according to the access categories. The retransmission control program may determine the retransmission limit of the current service on the basis of a retransmission table setting retransmission limits for individual access categories.

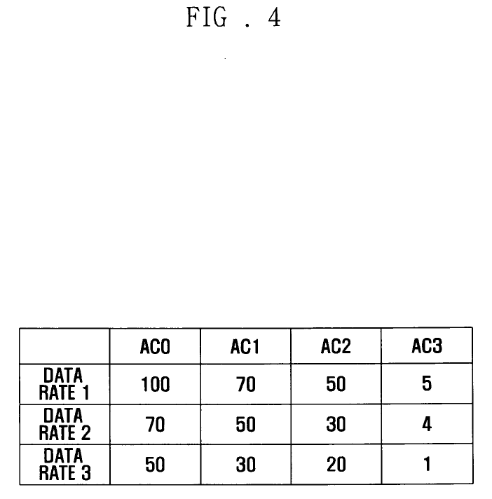

The data area may store data generated by the use of the mobile node 100, and various contents. When the display unit 140 includes a touch screen, the data area may store user data input through the touch screen. In particular, the data area may store a retransmission table that sets different retransmission limits for different access categories. The retransmission table may contain information regarding adjustment of the retransmission limits according to data rates reflecting radio environments between the mobile node 100 and the AP 200. The retransmission table is further described in connection with FIG. 4.

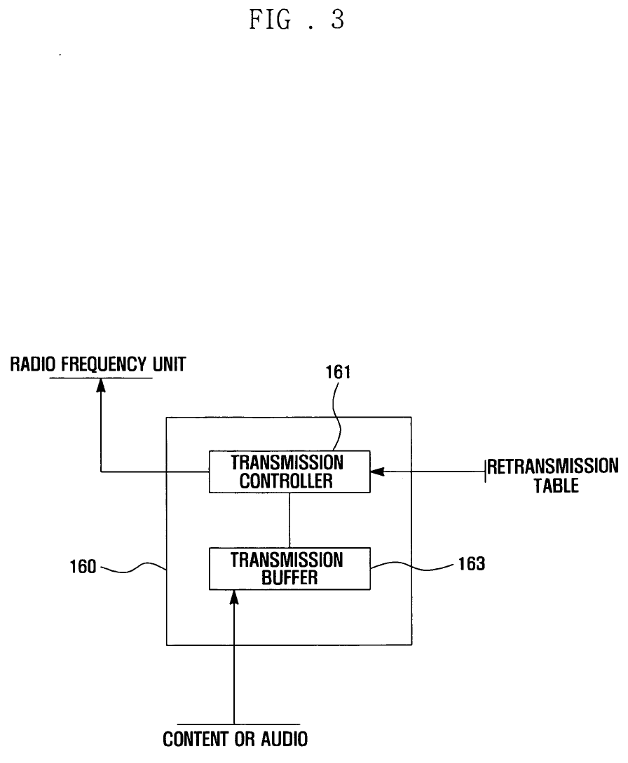

The control unit 160 controls supply of power to the components of the mobile node 100 for initialization, controls signal exchange between the components, and controls the number of retransmissions for each access category in response to a user request. To achieve this, the control unit 160 includes a transmission controller 161 and a transmission buffer 163, as shown in FIG. 3.

The transmission controller 161 identifies the access category of a service activated through the input unit 120. For example, when the user places a voice call through the input unit 120, the transmission controller 161 may identify the access category as audio on the basis of a voice call request signal from the input unit 120. When a voice call is received through the radio frequency unit 110 from another mobile node, the transmission controller 161 may identify the access category as audio on the basis of a voice call notification signal from the radio frequency unit 110. When the user selects a menu item mapped to a video call or video transmission service for sending captured images to the AP 200, the transmission controller 161 may identify the access category as video on the basis of the selection signal of the user. When the user selects a menu item for sending a content stored in the storage unit 150 through the AP 200 to another mobile node, transmission controller 161 may identify the access category on the basis of the selection signal of the user. That is, the transmission controller 161 may identify the access category of a service or application when an input signal is generated to select a particular menu item or application program for activation. The transmission controller 161 may also identify the access category as one of audio, video, best effort and background when a call request signal is received from an external entity.

After identification of the access category, the transmission controller 161 may limit the number of retransmissions with reference to the retransmission table stored in the storage unit 150. For example, for an audio service, the transmission controller 161 may set the retransmission limit to a small value in consideration of the real-time constraint. For a best effort or background data transfer service, the transmission controller 161 may set the retransmission limit to a large value in consideration of the error-free delivery constraint. After setting the retransmission limit, the transmission controller 161 may notify the AP 200 of the retransmission limit. Then, the AP 200 may operate according to the access category and related retransmission limit from the mobile node 100. For a piece of data, the transmission controller 161 may accumulate the number of retransmissions for retransmission control.

The transmission controller 161 may adjust the retransmission limit for a given access category on the basis of the quality of a signal from the AP 200. To be more specific, when the mobile node 100 approaches, the AP 200 may check the radio environment in relation to the mobile node 100 as part of establishing a data transmission channel. The AP 200 may send the radio environment information to the mobile node 100. The mobile node 100 may obtain information on the radio environment by autonomously checking the radio environment in the process of establishing a communication channel, or may receive information on the radio environment from the AP 200. Then, the transmission controller 161 may adjust the retransmission limit on the basis of the obtained information on the radio environment. For example, when the radio environment is better than or equal to a threshold level, the transmission controller 161 may reduce the retransmission limits for the access categories by a preset value. When the radio environment is worse than the threshold level, the transmission controller 161 may increase the retransmission limits for the access categories by a preset value. Here, even if the radio environment is worse than the threshold level, the transmission controller 161 need not increase (or may decrease) the retransmission limit for a particular access category (such as audio demanding the real-time constraint) in consideration of service characteristics.

The transmission buffer 163 temporarily saves data that is generated by the mobile node 100 or collected through the microphone after establishing a communication channel to the AP 200. The transmission buffer 163 keeps a particular piece of data for a preset time to cope with a retransmission request from the AP 200. If the number of retransmissions exceeds the retransmission limit, the piece of data may be treated as lost. The data treated as lost may be deleted from the transmission buffer 163, and a retransmission request for the data arriving thereafter may be ignored. Here, for a content file, the control unit 160 controlling the transmission buffer 163 may set the retransmission limit to a value larger than that for audio, and the transmission buffer 163 may retain content data for a time duration corresponding to the retransmission limit after the content data has been sent to the AP 200. The control unit 160 may vary the retransmission limit according to data characteristics. For example, a content file may be divided into data packets containing information to be played back and header packets containing meta information and synchronization information. For transmission of the content file, the control unit 160 may set the retransmission limit for a header packet to a value larger than that for a data packet because the header packet may be essential to content playback. In most cases, loss of a single data packet may be recovered or may result in tolerable impact. Adjustment of the retransmission limits may be performed with reference to the retransmission table. For a content file divisible into header packets and data packets, use of different retransmission limits may be encouraged by the retransmission table.

As described above, the mobile node of the present invention may set different retransmission limits in consideration of access categories and packet properties, enabling data transmission conforming to service characteristics.

FIG. 4 illustrates a retransmission table. The retransmission table in FIG. 4 is an example of setting different retransmission limits to different access categories. The present invention is not limited by the numeric values or categories given in the retransmission table. That is, the access categories may be further refined and the retransmission limits may be adjusted in consideration of characteristics of the communication module of the mobile node and characteristics of the access points.

Referring to FIG. 4, the retransmission table contains four access categories AC0, AC1, AC2 and AC3, and three data rates ‘rate 1’, ‘rate 2’ and ‘rate 3’. In order of strictness of the real-time constraint (from loose to strict), the access categories AC0, AC1, AC2 and AC3 may correspond respectively to the WMM access categories: background, best effort, video and audio. That is, access categories may be defined according to real-time constraints of services or applications.

The data rate may correspond to the radio environment between the mobile node and access point. In the retransmission table, the data rate ‘rate 1’ indicates a case where the radio environment between the mobile node and access point is poor (i.e., signal quality is less than a preset threshold level); the data rate ‘rate 2’ indicates a case where the radio environment is acceptable (i.e., signal quality is about the threshold level); and the data rate ‘rate 2’ indicates a case where the radio environment is good (i.e., signal quality is higher than the threshold level). All though data rates are classified into three levels in the description, the present invention is not limited thereto. Classification of data rates may be changed if necessary for system design or implementation.

In the retransmission table, for data rate ‘rate 1’, the retransmission limits for AC0, AC1, AC2 and AC3 are set respectively to 100, 70, 50 and 5. For data rate ‘rate 2’, the retransmission limits for AC0, AC1, AC2 and AC3 are set respectively to 70, 50, 30 and 4. For data rate ‘rate 3’, the retransmission limits for AC0, AC1, AC2 and AC3 are set respectively to 50, 30, 20 and 1. As described above, the retransmission table is designed so that the retransmission limit for an access category emphasizing a strict real-time constraint is less than that for an access category emphasizing an error-free delivery constraint. Hence, when a service of an access category emphasizing a strict real-time constraint is activated, the mobile node is caused to perform fast data transmission without delay. When a service of an access category emphasizing an error-free delivery constraint is activated, the mobile node is caused to perform robust data transmission without data loss.

Next, a description is given of a data transmission method based on WMM.

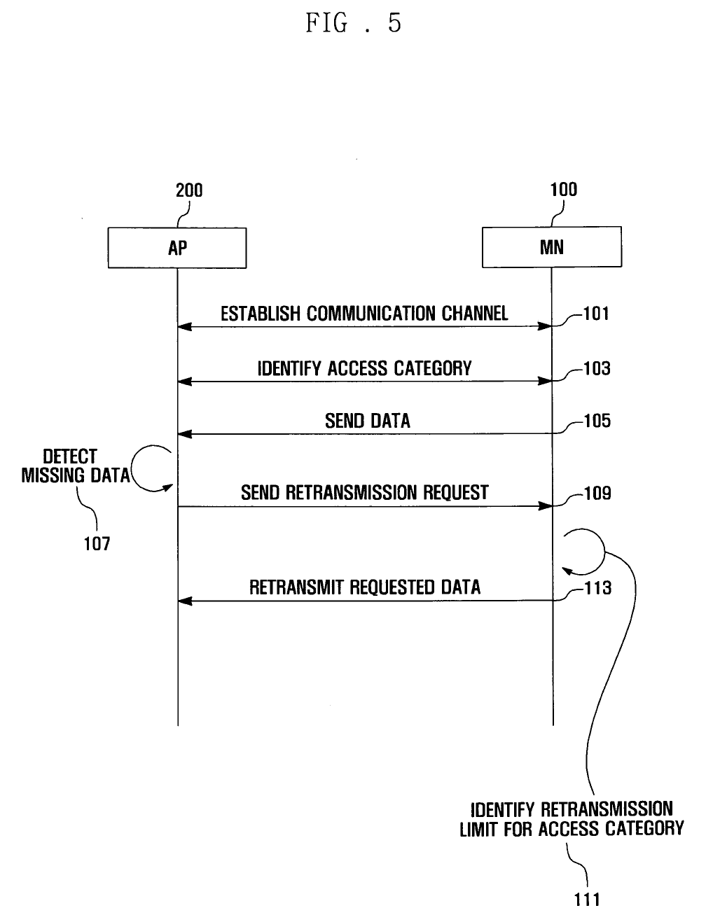

FIG. 5 illustrates a sequence diagram of a data transmission method according to another exemplary embodiment of the present invention.

Referring to FIG. 5, after activation of the AP 200 and the mobile node 100, when the mobile node 100 enters the range covered by the AP 200, the mobile node 100 may establish a communication channel to the AP 200 and register with the AP 200 through the communication channel (101). At this step, the AP 200 may periodically broadcast a discovery signal to search for a mobile node within range. Upon coming within range, the mobile node 100 may receive a discovery signal broadcast by the AP 200. Upon reception of the discovery signal, the mobile node 100 may send a response signal to the AP 200, and obtain an IP address from the AP 200.

In response to selection of an application by the user, the mobile node 100 and AP 200 identify the access category related to the application (103). At this step, the user may select a specific application program activating a service of a given access category. The application program may activate one of an audio service, a video service, and a data transfer service. The mobile node 100 may identify the access category on the basis of the selection signal from the input unit 120 and send the access category information to the AP 200. Hence, the AP 200 may be aware of the access category to be used for data transmission. Here, transmission of the access category information may be skipped. That is, data transmission may be performed without reference to the access category.

The mobile node 100 sends data associated with the activated service to the AP 200 according to the identified access category (105). That is, when an audio service is activated, the mobile node 100 may collect an audio signal through the microphone, and send audio data to the AP 200. When a data transfer service is activated, the mobile node 100 may send a content that is stored in the storage unit 150 and selected by the user to the AP 200. Particularly, in the case of a data transfer service related to content data, the mobile node 100 may display a popup window enabling the user to directly set the access category to one of best effort and background, or may set the access category to one of best effort and background by default.

The AP 200 receives data packets from the mobile node 100 and detects a missing packet (107). A missing packet can be detected by checking sequence numbers of data packets. Detection of a missing packet may be performed by one of the sending end AP connected to a sending mobile node or the receiving end AP connected to a receiving mobile node. That is, the sending end AP checks the arrival order of data packets coming from the mobile node 100, or the receiving end AP checks the arrival order of data packets coming from the sending end AP. The AP 200 may use a jitter buffer to cope with time delay of data packets. When a particular packet does not arrive within a preset time delay, the AP 200 sends a retransmission request to the mobile node 100 (109). Making a retransmission request may be performed by one of the sending end AP and the receiving end AP, while the mobile node 100 physically receives a retransmission request from the sending end AP.

Upon reception of the retransmission request from the AP 200, the mobile node 100 identifies the retransmission limit of the currently active service on the basis of the retransmission table and the access category (111). The mobile node 100 may utilize the adjusted retransmission limit in consideration of the radio environment.

When the number of retransmissions for the requested packet does not exceed the retransmission limit, the mobile node 100 retransmits the requested packet to the AP 200 (113). When the number of retransmissions for the requested packet exceeds the retransmission limit, the mobile node 100 does not retransmit the requested packet and may discard the requested packet. The mobile node 100 may send a message indicating packet loss to the AP 200, or may ignore the retransmission request. Thereafter, the mobile node 100 may delete the requested packet from the transmission buffer. When the requested packet does not arrive within a preset waiting time after sending the retransmission request, the AP 200 may treat the requested data as lost.

As described above, the data transmission method sets different retransmission limits for different access categories, enabling efficient data transmission conforming to service characteristics.

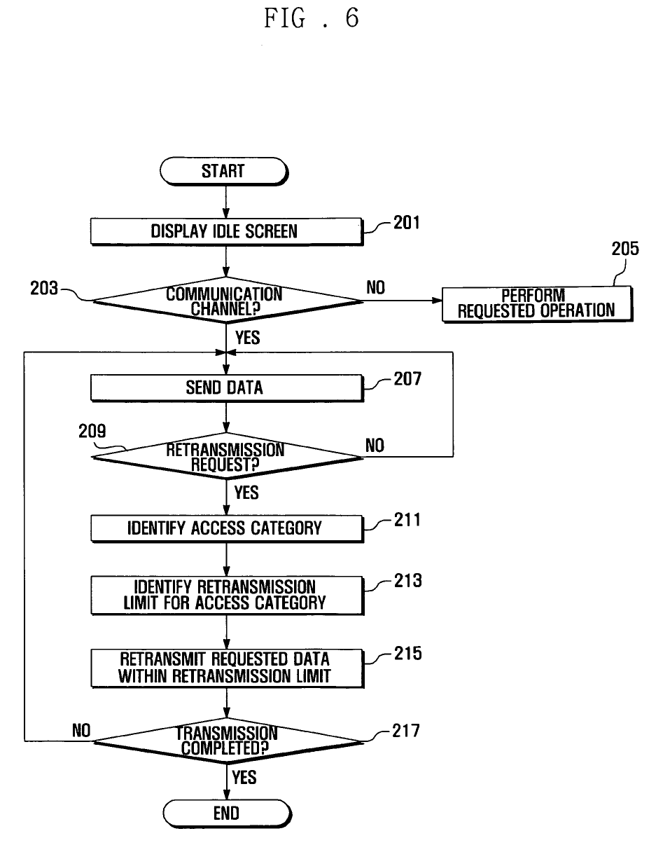

FIG. 6 illustrates a flow chart of a procedure performed by the mobile node in the data transmission method of FIG. 5.

Referring to FIG. 6, upon power on, the mobile node boots up and displays a preset idle screen on the display unit (201). When a signal is input from the user, the mobile node checks whether the input signal is related to selection of an application program requiring a communication channel (203). If the input signal is not related to a communication channel, the mobile node performs a requested operation such as file playback or file search (205).

If the input signal is related to a communication channel, the mobile node establishes a communication channel to an AP, and performs data transmission (207). To establish a communication channel, the mobile node enters the range covered by an AP and obtains an IP address from the AP. The mobile node activates the selected application program related to a service of a given access category. The access category may be one of audio, video, best effort and background. The mobile node performs an initialization procedure together with the AP for data transmission related to the activated application program. After initialization, the mobile node starts to send data for the application program according to the selected access category.

The mobile node checks whether a retransmission request is received from the AP (209). If a retransmission request is not received, the mobile node returns to step 207 for continued data transmission.

If a retransmission request is received, the mobile node identifies the access category of the currently active service (211). The access category may already be identified at step 203 for application selection. The mobile node refers to the retransmission table stored in the storage unit, and identifies the retransmission limit on the basis of the identified access category (213). When the number of retransmissions for the requested packet does not exceed the retransmission limit, the mobile node retransmits the requested packet to the AP (215). To handle retransmission, the mobile node may retain transmitted packets in the transmission buffer. The time to retain a transmitted packet in the transmission buffer may be fixed by the design process or may be determined relative to the time of the retransmission request. In other words, the time to delete a transmitted packet from the transmission buffer may be set in consideration of the arrival time of a retransmission request for the packet from the corresponding mobile node. When a retransmission request for a packet is received, the mobile node may discard packets preceding the requested packet from the transmission buffer and keep packets subsequent to the requested packet in the transmission buffer.

When the number of retransmissions for the requested packet exceeds the retransmission limit, the mobile node does not retransmit the requested packet and may discard the requested packet from the transmission buffer. That is, the mobile node may treat the requested packet as lost and ignore the retransmission request.

Thereafter, the mobile node checks whether data transmission is completed (end of service) (217). If data transmission is not completed yet, the mobile node returns to step 207 for continued data transmission.

As described above, when a sending end AP or receiving and AP employing a jitter buffer detects a missing packet through checking the sequence numbers of received packets and sends a retransmission request, the mobile node retransmits the requested packet within the retransmission limit associated with the access category of the service, achieving acceptable service quality.

In the description, the data transmission method applies different retransmission limits to services of different access categories, and is implemented between the mobile node and the sending end AP or receiving end AP with reference to the retransmission table. The data transmission method may also be applied between the sending end AP and the receiving end AP, and between the receiving end AP and the receiving mobile node. That is, the data transmission method of the present invention is usable between any pair of network entities of a data transmission system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A data transmission method based on Wi-Fi Multimedia, comprising:
identifying an access category to be used for data transmission between a sending end and a receiving end;
setting, by the sending end, different retransmission limits for different access categories;
receiving, by the sending end, a retransmission request for missing data from the receiving end; and
determining, by the sending end, whether to retransmit the requested data through comparison between the number of retransmission requests received and the retransmission limit related to the identified access category.

2. The data transmission method of claim 1, further comprising at least one of:
determining, when the number of retransmission requests received exceeds the retransmission limit, not to retransmit the requested data; and
discarding, when the number of retransmission requests received exceeds the retransmission limit, the requested data from a buffer.

3. The data transmission method of claim 1, wherein identifying an access category comprises selecting one of access categories including audio, video, best effort and background to be used for data transmission between the sending end and the receiving end.

4. The data transmission method of claim 3, wherein setting different retransmission limits comprises:
setting the retransmission limit for a background data service to a value larger than that for a best effort data service;
setting the retransmission limit for a best effort data service to a value larger than that for a video transfer service; and
setting the retransmission limit for a video transfer service to a value larger than that for an audio transfer service.

5. The data transmission method of claim 3, wherein setting different retransmission limits comprises setting, for best effort and background access categories, the retransmission limit for a header packet to a value greater than that for a data packet.

6. The data transmission method of claim 1, wherein setting different retransmission limits comprises setting the retransmission limit for a data transfer service emphasizing a real-time constraint to a value less than that for a data transfer service emphasizing an error-free delivery constraint.

7. The data transmission method of claim 1, further comprising:
testing the radio environment between the sending end and the receiving end; and
adjusting, by the sending end, the retransmission limits.

8. The data transmission method of claim 7, wherein adjusting the retransmission limits comprises increasing, when the radio environment is worse than a threshold level, the retransmission limits by a preset value, and reducing, when the radio environment is better than or equal to the threshold level, the retransmission limits by a preset value.

9. The data transmission method of claim 8, wherein adjusting the retransmission limits comprises maintaining or reducing the retransmission limit for the audio access category.

10. A data transmission apparatus based on Wi-Fi Multimedia, comprising:
a sending end configured to set different retransmission limits for different access categories, and determine, upon reception of a retransmission request, whether to retransmit the requested data through comparison between the number of retransmission requests received and the retransmission limit related to a selected access category, and a receiving end sending a retransmission request for missing data to the sending end.

11. The data transmission apparatus of claim 10, wherein the sending end comprises:
a transmission buffer configured to store data; and
a transmission controller configured to control an operation to transmit the data stored in the transmission buffer to the receiving end, and to retransmit, when a retransmission request is received from the receiving end and the number of retransmission requests received does not exceed the retransmission limit, the stored data to the receiving end.

12. The data transmission apparatus of claim 11, wherein the transmission controller is configured to determine, when the number of retransmission requests received exceeds the retransmission limit, not to retransmit the requested data.

13. The data transmission apparatus of claim 11, wherein the transmission controller is configured to discard, when the number of retransmission requests received exceeds the retransmission limit, the requested data from the transmission buffer.

14. The data transmission apparatus of claim 11, wherein the sending end is configured to select one of access categories including audio, video, best effort and background.

15. The data transmission apparatus of claim 11, wherein the sending end further comprises a storage unit configured to store a retransmission table that sets the retransmission limit for a background data service to a value greater than that for a best effort data service, sets the retransmission limit for a best effort data service to a value greater than that for a video transfer service, and sets the retransmission limit for a video transfer service to a value greater than that for an audio transfer service.

16. The data transmission apparatus of claim 11, wherein the sending end further comprises a storage unit configured to store a retransmission table that sets, for best effort and background access categories, the retransmission limit for a header packet to a value greater than that for a data packet.

17. The data transmission apparatus of claim 11, wherein the sending end further comprises a storage unit configured to store a retransmission table that contains information regarding adjustment of the retransmission limits according to data rates reflecting the level of the radio environment between the sending end and the receiving end.

18. The data transmission apparatus of claim 17, wherein the transmission controller is configured to control an operation to increase, when the radio environment is worse than a threshold level, the retransmission limits by a preset value, and to reduce, when the radio environment is better than or equal to the threshold level, the retransmission limits by a preset value.

19. The data transmission apparatus of claim 18, wherein the transmission controller is configured to control an operation to maintain or reduce the retransmission limit for the audio access category.

20. The data transmission apparatus of claim 11, wherein the sending end is one of a mobile node and an access point and the receiving end is one of a mobile node and an access point.
